(19) United States
(12) Patent Application Publication
(10) Pub. No.: US 2009/0072779 A1
(43) Pub. Date: Mar. 19, 2009

(54) Low Voltage Energy System

(76) Inventor: Kurt KUHLMANN, San Jose, CA (US)

Correspondence Address: Zarian Midgley & Johnson PLLC, University Plaza, 960 Broadway Ave., Suite 250, Boise, ID, 83706, US

(21) Appl. No.: 11/855,390

(22) Filed: Sep. 14, 2007

(51) Int. Cl. H02J 7/00

(52) U.S. Cl. 320/101

(57) ABSTRACT

An energy system for transferring energy from a lower voltage energy source, such as a single photovoltaic cell or two photovoltaic cells connected in series, to a higher voltage energy storage, such as a capacitor or one or more batteries. The system uses a controller operating from the higher voltage storage to control a boost converter which transfers energy from the lower voltage source to the higher voltage storage.

### BACKGROUND

The present application relates generally to low voltage energy systems and, more particularly, to systems and methods for transferring energy from a lower voltage energy source to a higher voltage energy storage.

Energy sources with very low voltages such as photovoltaic cells require specialized circuitry in a corresponding boost converter and controller. A specialized low voltage controller is often costly and not suited to other control tasks. Users must often have additional circuits, e.g., one circuit for the low voltage controller and another circuit for other control tasks.

Other approaches connect numerous low voltage sources in series in order to obtain a high enough voltage to operate the controller. For example, photovoltaic cells are almost always connected in series to create more usable higher voltages since the output of a single silicon cell is frequently only about 0.5 volts. This necessitates building panels with cells or pieces of cells wired together in series and sealed. Such series strings often require the addition of bypass diodes, adding undesirable expense and complexity. All this requires costly manufacturing, especially when the application requires only a few watts of power. Other drawbacks include the risk of failure of additional interconnections and components.

### SUMMARY

The present application addresses the above-mentioned drawbacks associated with existing low voltage energy systems. The application describes a low voltage energy system that can operate with a low voltage energy source without the need for specialized low voltage circuitry. The system advantageously uses the higher voltage of an energy storage to operate a controller. This approach allows the use of general purpose, low cost microprocessors as well as application specific integrated circuits (ASICs) as the controller.

In one embodiment, the low voltage energy system has a source and a boost converter transferring energy from the source to a higher voltage storage. A controller energized from the higher voltage storage operates the converter and monitors the source. The source supplies energy to the converter, via the converter input. The converter output transports the energy, now at a higher voltage to the storage. The controller, energized by the storage via a controller energy link, both monitors the source by a source monitor channel and controls the converter with a converter control.

The storage may comprise, for example, a capacitor or battery. The controller can also control the converter to follow the desired charging profile of the storage. In expanded systems, a single controller can operate a parallel combination of boost converter stages. The source may comprise a single low voltage photovoltaic cell or two such cells connected in series. Using the source monitor channel, the controller can perform maximum power point tracking to improve source operation and the power extracted from it. Such maximum power point tracking can be a complex algorithm or as simple as controlling the converter to maintain the source voltage at a predetermined fraction of the source open circuit voltage.

As the storage energizes a load, the controller uses a load monitor channel to observe such load parameters as temperature, voltage, current, and speed. The controller then employs a load control to operate the load based on the monitored parameters and prescribed load requirements. When the source is intermittent, such as with photovoltaic cells, the controller can control the load even to the point of turning it off completely if the level of the storage falls below a specified level.

Further disclosed are methods of accumulating and controlling energy including providing a source, a storage, a converter, a controller, a load and then operating the converter with the controller to transfer energy from the lower voltage source to the higher voltage storage. The controller can further monitor the source and adjust the converter to improve the source operation. Still further, the controller can monitor the storage and adjust the converter to improve storage operation and/or control the load to improve storage operation, even to the point of reducing the load energy consumption if the storage voltage falls below a specified level.

These and other embodiments of the present application will be discussed more fully in the description. The features, functions, and advantages can be achieved independently in various embodiments of the claimed invention, or may be combined in yet other embodiments.

### BRIEF DESCRIPTION OF THE DRAWINGS

The accompanying drawings, which are incorporated in and constitute a part of this specification, illustrate exemplary embodiments of the present application.

FIG. 1 illustrates one embodiment of a low voltage energy system.

FIG. 2 illustrates one embodiment of the low voltage energy system of FIG. 1 with a load.

FIG. 3 illustrates an embodiment of the low voltage energy system with multiple boost converter stages.

FIG. 4 illustrates example current waveforms of the converter stages of FIG. 3.

FIG. 5 illustrates an embodiment of a boost converter stage.

FIG. 6 illustrates the voltage-current and power curves of a photovoltaic cell.

FIG. 7 is a flow chart outlining embodiments of operating methods of a low voltage energy system.

Like reference numbers and designations in the various drawings indicate like elements.

### DETAILED DESCRIPTION

In the following description, reference is made to the accompanying drawings that form a part thereof, and in which is shown by way of illustration specific exemplary embodiments in which the invention may be practiced. These embodiments are described in sufficient detail to enable those skilled in the art to practice the invention, and it is to be understood that modifications to the various disclosed embodiments may be made, and other embodiments may be utilized, without departing from the spirit and scope of the present invention. The following detailed description is, therefore, not to be taken in a limiting sense.

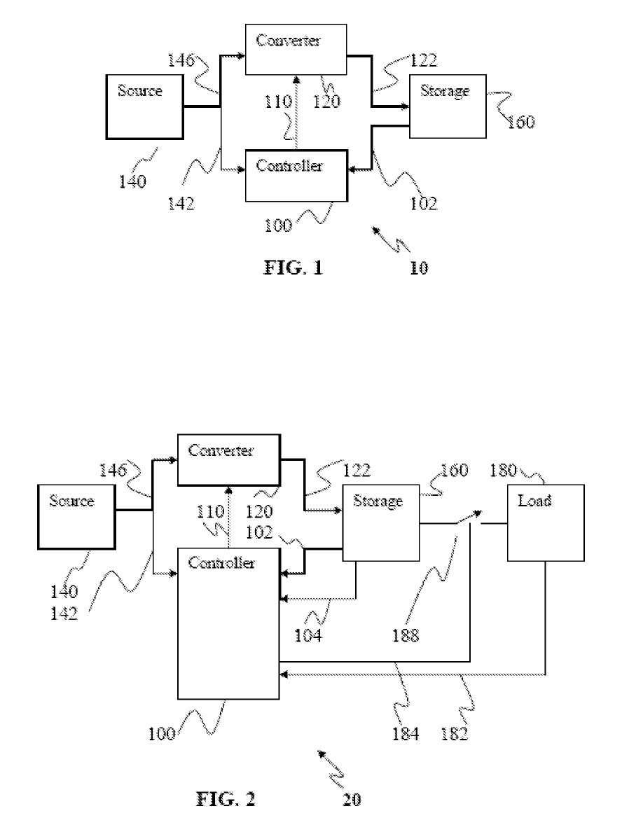

FIG. 1 shows one embodiment of a low voltage energy system 10. In the illustrated embodiment, the system 10 comprises a low voltage energy source 140 connected to a boost converter 120 via a converter input 146. In some embodiments, source 140 comprises a single photovoltaic cell or two photovoltaic cells connected in series. Thus, source 140 preferably operates at a source voltage of less than about 1.0 volts, which is considerably lower than the source voltage of conventional boost converters.

The converter 120 connects to an energy storage 160 via a converter output 122. In some embodiments, storage 160 comprises one or more batteries, or chemical cells, such as lithium cells, nickel cadmium (NiCd) cells, or nickel metal hydride (NiMH) cells. In other embodiments, storage 160 may comprise a wide variety of other energy storage media such as other chemical cell types, capacitors, kinetic energy storage or combinations.

The system 10 further comprises a controller 100 connected to the converter 120 via a converter control 110. In some embodiments, converter control 110 controls the converter 120 by way of pulse width modulation techniques. In other embodiments, other modulation and control methods are possible, and are well known to those skilled in the art of boost converters.

In operation, the controller 100 receives energy from the storage 160 via the controller energy link 102. Powering the controller from a higher voltage storage 160 instead of a lower voltage source 140 allows a greater selection of controllers and design choices. The controller 100 monitors the state of the energy source 140 with the source monitor channel 142. In some embodiments, the source monitor channel 142 monitors simply the voltage of the source 140. In other embodiments, the channel 142 can monitor other source parameters such as current, temperature, and insolation. If the source 140 is capable of producing sufficient energy, the controller 100 will operate the converter 120 with the converter control 110. The converter 120 receives input energy from the source 140 through the converter input 146. The converter 120 boosts the voltage of the input energy and stores it in the storage 160 via converter output 122.

FIG. 6 shows typical voltage-current and power curves for a photovoltaic cell. As described above, such a cell may serve as the energy source 140 in some embodiments. An example silicon cell has less than about 1.0 volt open circuit shown as Voc. This voltage is not adequate to operate most general purpose microcontrollers or even most custom integrated circuits. When the cell is shorted, it provides the maximum short circuit current indicated by Isc. The curve labeled P is the power provided by the cell at the various combinations of current and voltage on the V-I curve. As shown in FIG. 6, there is a maximum power point Pmax obtained by operating the cell at Imp and Vmp.

Referring again to FIG. 1, in some embodiments, the controller 100 monitors both current and voltage of the source 140 with the source monitor channel 142 and then uses these parameters to perform calculations of source power output. The controller 100 then operates converter 120 at Imp and Vmp with converter control 110 to maximize the power output of the source 140. This technique is referred to as maximum power point tracking.

While it is desirable in many cases to maximize the power output of source 140, it can also be desirable to avoid the losses associated with monitoring the source current. Therefore, in some embodiments, controller 100 monitors only the open circuit voltage of the source 140 with the source monitor channel 142 and approximates maximum power point tracking by operating the converter 120 at a predetermined fraction of the open circuit voltage. This predetermined fraction is typically about 71% to 78% for many photovoltaic cells, but can vary with source type.

In one preferred embodiment, the predetermined fraction is about 77% of the source open circuit voltage. In other embodiments, the predetermined fraction can be based on empirical data of the source 140 used. For example, FIG. 6 is a representation of a silicon cell at a particular temperature and insolation (illumination). In practice, each cell has a family of curves generated by various levels of insolation and various temperatures. Thus, in some embodiments, the controller 100 may utilize temperature or insolation level inputs to control the operation of the source 140. This predetermined fractional method approximates maximum power point tracking while advantageously avoiding the losses associated with monitoring source current.

FIG. 2 illustrates one embodiment of an expanded energy system 20. The expanded energy system 20 comprises the energy system 10 of FIG. 1 with a load 180, connected to the storage 160 via a switch 188 and load control 184. While FIG. 2 shows a single switch 188, other embodiments can include more sophisticated outputs such as multiple switches to control motors or analog outputs to control linear circuits. Load monitor channel 182 passes load operating parameters to the controller 100. In some embodiments, the load monitor channel 182 monitors load voltage. Other embodiments include the monitoring of temperature, insolation, illumination and any number of inputs necessary to intelligently control the load 180. Storage monitor channel 104 passes storage 160 operating parameters to the controller 100. In some embodiments, storage monitor channel 104 provides information on the storage 160 voltage to the controller 100. In other embodiments, storage monitor channel 104 passes parameters such as temperature, state of charge for batteries or revolutions per minute in the case of kinetic energy storage.

In operation, the controller 100 monitors the voltage at the storage 160 with the storage monitor input 104. The controller 100 then operates the boost converter 120 via the converter control 110 in ways to improve the operation of the energy storage 160. In some embodiments, the storage 160 comprises a battery, and the controller 100 implements charging profiles specific to the particular battery type based on state of charge and battery temperature.

FIGS. 1 and 2 show the controller 100 energized from the higher voltage storage 160 instead of the source 140. This enables the use of low cost microcontrollers. These general purpose microcontrollers often include internal peripherals such as timers, counters, analog to digital converters, pulse width modulators, communication links and digital input/output. Such controllers 100 typically have enough processing power to monitor the source 140 and the storage 160, while controlling both the converter 120 and a variety of loads 180.

In one preferred embodiment, the controller 100 comprises a PIC16F506 microcontroller manufactured by Microchip Corporation of Chandler, Ariz. This particular device requires a power supply of 2.0 volts minimum. If the source 140 is one or two photovoltaic cells, the source voltage is typically not enough to operate the controller 100. If, however, the energy storage 160 is a single lithium cell or a plurality of nickel cadmium, nickel metal hydride or alkaline cells, the storage 160 can provide enough voltage to operate the controller 100. Once operating, the controller 100 controls the boost converter 120 to maintain the energy storage 160 at a sufficient voltage to operate the controller 100. The controller 100 uses the storage monitor channel 104 and reduces or shuts off the load 180 via load control 184 if source 140 lacks sufficient energy to maintain the voltage at the storage 160. Other embodiments may use a custom integrated circuit for the controller 100.

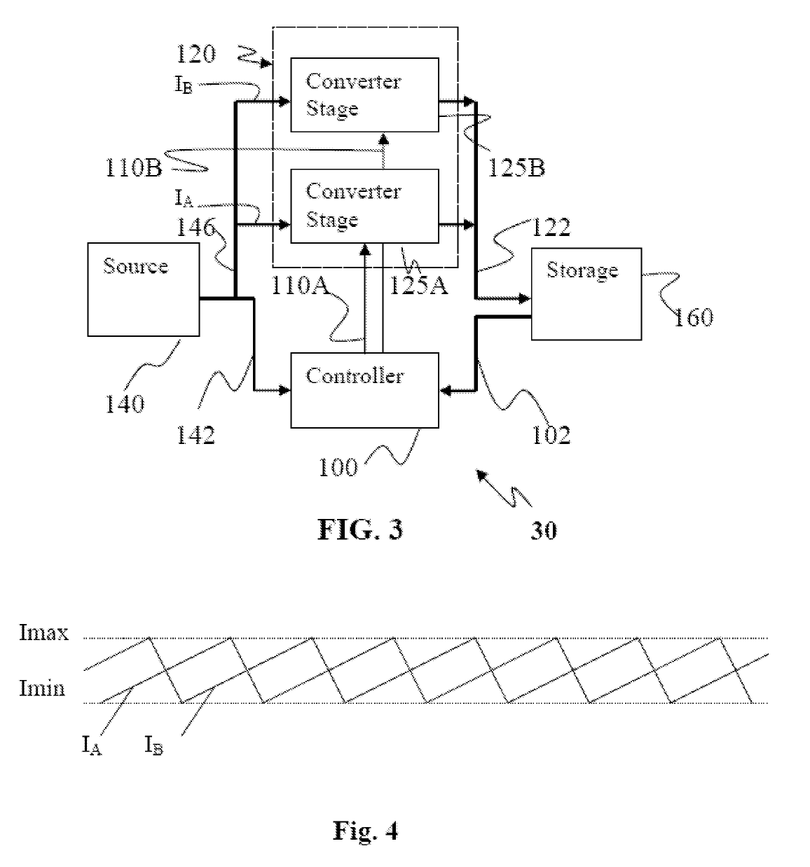

FIG. 3 shows an embodiment of an energy system 30 with a plurality of converter stages 125. In the illustrated embodiment, a converter 120 comprises a plurality of converter stages 125A and 125B. The single controller 100 controls both converter stages 125A and 125B via converter controls 110A and 110B, respectively. While requiring additional components, such a topology has advantages. In a typical converter 120, energy losses are proportional to the square of the current through the converter 120. Thus, cutting the converter current in half by splitting it between two converters reduces the overall I²R losses. “R” in this example corresponds to the resistance of coils or the on resistance R_{DS}ON of the semiconductor switches.

Another advantage of using multiple converter stages as shown in FIG. 3 is the smoothing of the waveform of the energy source current as shown in FIG. 4. A smoother waveform allows the energy source 140 to operate closer to the maximum power point. The controller 100 synchronizes the operation of converter stages 120A and 120B through converter controls 110A and 110B to achieve lower losses and improved operation.

FIG. 4 shows the current drawn by the two converter stages 125A and 125B of FIG. 3. In operation, the controller 100 operates the converter stages 125A and 125B via converter controls 110A and 110B, respectively. The current through converter input 146 of FIG. 3 is composed of two components, I_{A} and I_{B}, as shown in FIG. 4. Both components, I_{A} and I_{B}, cycle between a minimum current Imin, and a maximum current Imax. The controller 100 operates converter controls 110A and 110B such that I_{A} and I_{B} are out of phase. This out of phase relationship between I_{A} and I_{B} reduces the peak currents seen by the source 140 and lowers the losses as discussed in conjunction with FIG. 3.

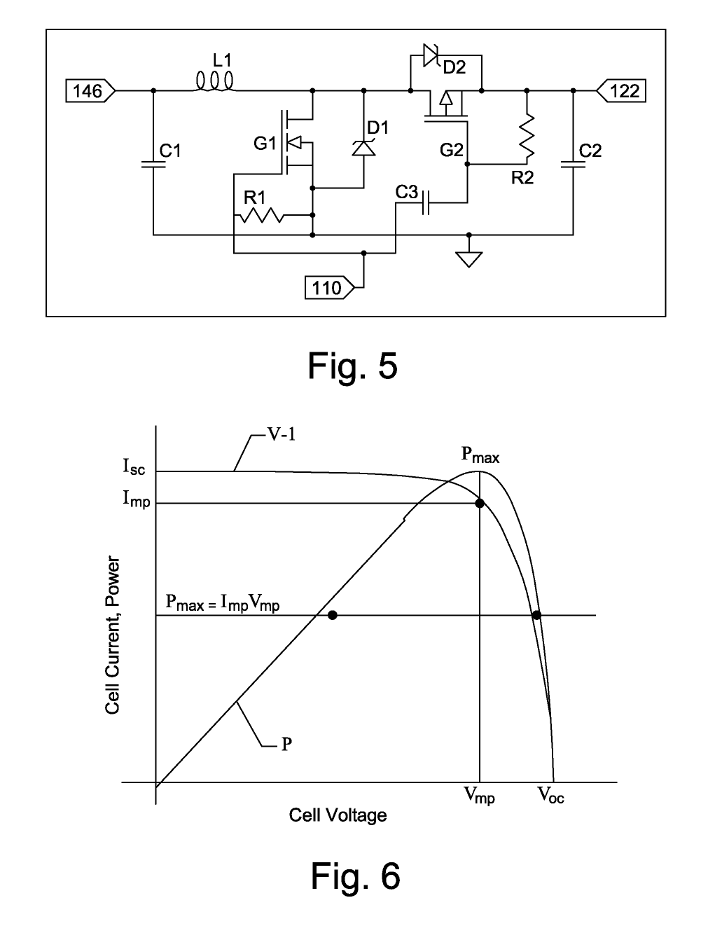

FIG. 5 shows an embodiment of converter stage 125. Converter input 146 connects to input capacitor C1 and the drain of input transistor Q1 through inductor L1. In a preferred embodiment, Q1 is a high speed N-channel power MOS FET. The other terminals of C1 and the source of Q1 return to ground. R1 connects across the gate and source of Q1, while diode D1 is typically integral to Q1. The junction of L1 and the drain of Q1 connect to the source of output transistor Q2. The drain of Q2 connects to the converter output 122 and output capacitor C2. The other terminal of C2 connects to ground. R2 connects across the gate and source of Q2. The anode of output diode D2 connects to the source of Q2 while the cathode of D2 connects to the drain of Q2. In a preferred embodiment, output diode D2 is a high speed shotkey diode and Q2 is a high speed P-channel power MOS FET. In other embodiments, C3, D2, Q2 and R2 can be eliminated, trading off efficiency for cost savings. Converter control 110 connects to the gate of Q1 and to the gate of Q2 through the Q2 gate capacitor C3.

In operation, converter control 110, which may be controlled by the controller 100 discussed above, goes high turning on Q1 and causing current to build in L1. This current build up is shown by the rising ramp portion of either I_{A} or I_{B} shown in FIG. 4. After sufficient current flows in L1, converter control 110 goes low and shuts off Q1. This action turns on Q2 and allows the current flowing in L1 to pass through Q2 and D2 to the converter output 122. D2 conducts during the turn-on portion of Q2, preventing excessive voltage spikes across Q2. When fully on, Q2 conducts the major share of the current flowing into the converter output 122 reducing loses associated with D2. From converter output 122, the current flows into the storage 160, as discussed above. R1 and R2 aid in turning off Q1 and Q2 respectively. C1 and C2 act to smooth out current spikes on the converter input and converter output respectively.

FIG. 5 shows one exemplary embodiment of a boost converter stage 125. Other boost converter types are possible, including those using transformers and switched capacitor networks. Other embodiments may eliminate Q2, R2 and C3, relying on only diode D2. Still other embodiments may eliminate C1 and C2 depending upon the required operating parameters of the energy source 140, energy storage 160, load 180 and other components.

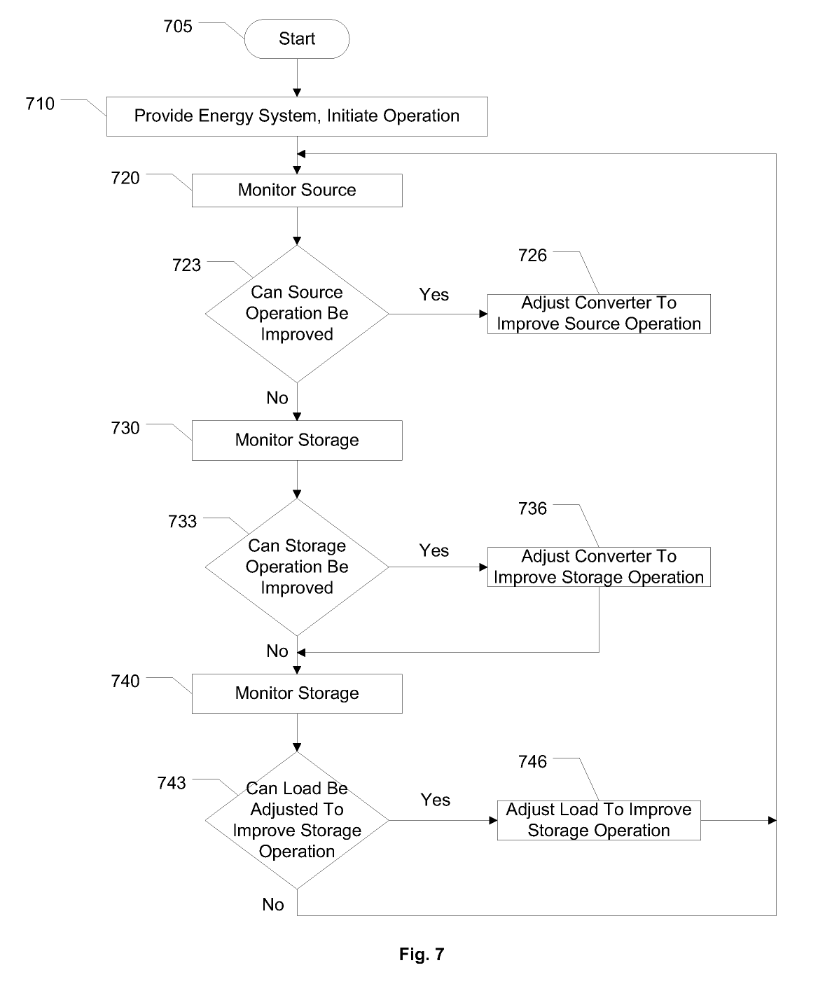

The flow chart of FIG. 7 illustrates embodiments of operating methods of the energy systems described above. Operation starts at block 705 and proceeds to block 710, where a suitable low voltage energy system 10 is provided and its operation initiated. Thus, as described above, block 710 may comprise providing a low voltage energy source 140 and an energy storage 160, connecting a converter 120 between the source 140 and the storage 160, providing a controller 100 energized by the storage 160, energizing a load 180 from the storage 160, and operating the converter 120 with the controller 100 to transfer energy from the source 140 to the storage 160.

At block 720, the controller 100 monitors the source 140. At block 723, the controller 100 determines if the source operation can be improved. If the source 140 has enough energy available, the controller 100 adjusts the operation of the converter 120 at block 726 to improve the source operation. In a preferred embodiment, this includes one of many algorithms for maximum power point tracking of a photovoltaic cell, or a simple adjustment for operating the photovoltaic cell at a predetermined fraction of its open circuit voltage. If the source 120 lacks any usable energy, such as a photovoltaic cell at night, the controller can also shut off the converter at block 726.

At block 730, the controller 100 monitors the storage 160 and, at block 733, determines if the operation of the storage 160 can be improved. If so, at block 736, the controller 100 adjusts the operation of the converter 120 to improve the operation of the storage 160. In a preferred embodiment, this improvement includes adjusting to a float charge for a charged battery, or adjusting the battery charging voltage to compensate for temperature.

At block 740, the controller 100 monitors the storage 160. At block 743, the controller 100 determines if the load 180 can be adjusted to improve operation of the storage 160. This operation varies greatly according to the load type. For example, the load 180 could comprise an electric sign, a motor, an emergency roadside phone or garden night light, each of which is application-dependent. In a preferred embodiment, when the energy of the storage 160 is low, the controller 100 could turn off the load 180 and maintain enough energy to run the controller 100 until the source 140 is once again available. In other embodiments, the controller 100 could run the load 180 at a reduced power level to conserve energy in the storage 160.

The low voltage energy system 10 described above exhibits a number of distinct advantages over conventional systems. For example, by limiting the source 140 to only one or two photovoltaic cells, the overall size and cost of the system 10 can advantageously be reduced. In some embodiments, for example, the system 10 takes the form of a portable, handheld battery charger than can be used in a wide variety of settings where power is unavailable (e.g., hiking, camping, traveling, emergency situations, etc.) to recharge the batteries used in many common electronic devices, such as cell phones, cameras, handheld computers, MP3 players, portable gaming devices, etc.

In addition, because the source 140 is limited to one or two photovoltaic cells, slight mismatches or irregularities among the cells does not significantly impact the performance of the system 10. This feature is in sharp contrast to conventional boost converters, which typically include numerous photovoltaic cells connected in series that must be carefully matched to one another. As a result, the cost of the system 10 is significantly lower than conventional systems, because it can utilize dissimilar or surplus silicon cells, which are less expensive.

As described above, the system 10 typically operates at a source voltage less than about 1.0 volts. In conventional boost converters, the controller draws power from the source, and such a low source voltage would necessitate a specialized controller, adding undesirable cost and complexity. In the system 10 described above, by contrast, the controller 100 is configured to draw power from the higher voltage energy storage 160. Therefore, the system 10 can advantageously utilize a wide variety of suitable low-cost controllers, such as the PIC16F506 microcontroller or an ASIC, which typically require an operating voltage greater than 1.0 volts.

Although this invention has been described in terms of certain preferred embodiments, other embodiments that are apparent to those of ordinary skill in the art, including embodiments that do not provide all of the features and advantages set forth herein, are also within the scope of this invention. Rather, the scope of the present invention is defined only by reference to the appended claims and equivalents thereof.

What is claimed is:

1. A low voltage energy system comprising:
a low voltage energy source comprising a photovoltaic cell and having a source voltage of no more than about 1.0 volts;
an energy storage having a storage voltage higher than the source voltage;
a boost converter having a converter input connected to the source and a converter output connected to the storage; and
a controller having an operating voltage higher than the source voltage, the controller being coupled to the energy storage via a controller energy link through which the controller is energized,
wherein the controller is configured to monitor the source voltage via a source monitor channel and is adapted to control the boost converter via a converter control.

2. The system of claim 1, wherein the energy storage comprises a capacitor.

3. The system of claim 1, wherein the energy storage comprises a battery.

4. The system of claim 3, wherein the controller controls a charging profile of the battery.

5. The system of claim 3, wherein the battery comprises a lithium cell, a nickel cadmium cell, or a nickel metal hydride cell.

6. The system of claim 1, wherein the converter comprises a parallel combination of converter stages.

7. The system of claim 1, wherein the low voltage source consists of a single photovoltaic cell or two photovoltaic cells connected in series.

8. The system of claim 1, further comprising a load configured to be energized by the storage.

9. The system of claim 8, wherein the controller is configured to monitor the load via a load monitor channel and to control the load via a load control.

10. The system of claim 1, wherein the system comprises a portable, handheld battery charger.

11. A low voltage energy system comprising:
a low voltage energy source having a source open circuit voltage, the source comprising no more than two photovoltaic cells;
an energy storage;
a boost converter configured to transfer energy from the source to the storage; and
a controller configured to be energized by the energy storage,
wherein the controller is configured to monitor the source voltage and to control the boost converter to maintain the source voltage at a selected fraction of the source open circuit voltage.

12. The system of claim 11, wherein the source comprises a surplus silicon cell or two dissimilar silicon cells.

13. The system of claim 11, wherein the selected fraction of the source open circuit voltage falls within the range of about 71% to 78%.

14. The system of claim 11, wherein the controller comprises an application specific integrated circuit.

15. The system of claim 11, wherein the system comprises a portable, handheld battery charger.

16. A method for accumulating and controlling energy, the method comprising:
providing a low voltage energy source comprising a photovoltaic cell and having a source voltage of no more than about 1.0 volts;
providing an energy storage having a storage voltage higher than the source voltage;
connecting a boost converter between the source and storage;
providing a controller having an operating voltage higher than the source voltage, the controller being energized by the storage; and
operating the boost converter with the controller to transfer energy from the source to the storage.

17. The method of claim 16, further comprising:
monitoring the source; and
adjusting the boost converter to improve the source operation.

18. The method of claim 16, further comprising:
monitoring the storage; and
adjusting the boost converter to improve the storage operation.

19. The method of claim 16, further comprising:
energizing a load from the source;
monitoring the storage; and
adjusting the load to improve the storage operation.

20. The method of claim 19, further comprising:
monitoring the storage voltage; and
reducing the load energy consumption when the storage voltage drops below a predetermined level.
